(19) United States
(12) Patent Application Publication
(10) Pub. No.: US 2005/0273329 A1
(43) Pub. Date: Dec. 8, 2005

(54) Speech recognition grammar creating apparatus, speech recognition grammar creating method, program for implementing the method, and storage medium storing the program

(75) Inventor: Kazue Kaneko, Kawasaki-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/147,836

(22) Filed: Jun. 8, 2005

(30) Foreign Application Priority Data
Jun. 8, 2004 (JP) 2004-170290

(51) Int. Cl. G10L 15/06

(52) U.S. Cl. 704/243; 704/257

(57) ABSTRACT

A speech recognition grammar creating apparatus which makes it possible to easily perform editing operations, such as division and modification of rules, without switching the window. A speech recognition grammar creating apparatus displays a rule name of a rule definition as a node on a left side of the rule definition and words and rule references of the rule definition as nodes on a left side of the rule definition, and connects the node on the left side and the nodes on the right side by links, whereby the edit of the rule definition is carried out. Rule definitions of the same grammar are displayed on the same window, and nodes and links of each of the rule definitions can be replaced between the rule definitions on the same window.

### BACKGROUND OF THE INVENTION

1. Field of the Invention

The present invention relates to a speech recognition grammar creating apparatus that generates grammars by describing speech-recognizable words and sentences, a speech recognition grammar creating method, a program for implementing the method, and a storage medium storing the program.

2. Description of the Related Art

Conventionally, in describing speech-recognizable contents as a grammar in advance, a speech recognition apparatus generally describes the grammar in ABNF (Augmented BNF) or the like. Tools have also been proposed which display and edit a grammar to be described using a GUI (Graphical User interface). For example, one of the tools has been proposed in Japanese Laid-Open Patent Publication (Kokai) No. H08-044384, in which a rule is defined in association with predetermined contents of speech, by arranging a plurality of rows each displaying words included in one attribute in parallel with each other, thereby displaying a speech recognition grammar associated with the rule, in tabular form. This tool, however, does not perform the display in tree structure or network form. Further, the tool displays and edits a grammar on a rule-by-rule basis, but is incapable of editing a plurality of rules on the same window, and requires switching of windows in editing so as to divide or integrate rules. Also, the tool places importance on the grammatical coherence, and edits the grammar by a method of expanding a branch of a tree structure or a network structure (extending a branch from the trunk or shortening an existing branch, therefore being incapable of making a floating branch apart from the trunk), and therefore has a low degree of freedom in editing.

For an information processing system that describes and edits knowledge, a method has also been proposed which edits descriptions of knowledge stored in a knowledge base, as a tree structure (see e.g. Japanese Laid-Open Patent Publication (Kokai) No. H08-147167). This method of editing a tree structure is incapable of handling a branch not connected to the root of the tree, and therefore, when applied to a grammar for speech recognition, the method is incapable of handling words or rule references not belonging to any rules. Further, the tree structure-based editing method is incapable of describing a grammar (speech recognition grammar) in the description method of ABNF, and therefore incapable of storing edit results in the description method of ABNF.

To describe speech-recognizable words or sentences using the above-described method to create a grammar, the user sometimes performs operations for defining a part of the rule as a separate rule or merge the same with a different rule during creation of the rule. In such a case, it is necessary to switch the window to another to perform editing, which makes the operations troublesome and can cause an oversight or like inconveniences.

Further, while rules are arranged or compiled, there can occur a case in which information not belonging to the rules needs to be described temporarily. Especially, in editing a grammar of a language, such as Japanese, in which words do not necessarily have a single pair of a notation and a pronunciation, if a pair of a notation and a pronunciation of a word are deleted before a rule to which the word belongs is not determined yet, to exclude the pair from a certain rule, it is necessary to enter the pair again when the rule to which the word belongs is determined, which needs extra labor.

### SUMMARY OF THE INVENTION

It is an object of the present invention to provide a speech recognition grammar creating apparatus and a speech recognition grammar creating methods, which make it possible to easily perform editing operations, such as division and modification of rules, without switching the window, a program for implementing the method, and a storage medium storing the program.

To attain the above object, in a first aspect of the present invention, there is provided a speech recognition grammar creating apparatus comprising a display control device that provides control such that a rule name of at least one rule definition is displayed as a node on a left side of the rule definition and at least one of word and rule reference of the rule definition are displayed as nodes on a right side of the rule definition, and an edit device that edits the rule definition by connecting the node on the left side and the nodes on the right side by links, wherein the edit device is capable of displaying rule definitions of a same grammar on a same window, and replacing nodes and links of each of the rule definitions between the rule definitions on the same window.

Preferably, the speech recognition grammar creating apparatus further comprises a storage device that is capable of readably storing edit results obtained by the edit device, in a storage method selected from a first storage method in which the edit results are stored as information consisting of grammar information necessary for speech recognition, and a second storage method in which the edit results are stored as information including the grammar information necessary for speech recognition and information on a location and a shape of each node and a location and a shape of each link.

Preferably, the speech recognition grammar creating apparatus further comprises a management device that manages rule names and words of the grammar, and the management device is operable when the node of the rule reference has been created on the right side of the rule definition, to automatically create the node of the rule name associated with the created node of the rule reference on the left side of the new rule definition.

More preferably, the management device is operable when the node of the rule reference has been newly created on the right side of the new rule definition, to inhibit the node of the rule name associated with the created node of the rule reference from being newly created on the left side of the rule definition, provided that the node of the rule name associated with the created node of the rule reference already exists.

More preferably, the management device is operable when a name of the rule reference of the node of the rule reference on the right side of the rule definition has been changed, to automatically create the node of the rule name associated with the node of the rule reference the name of which has been changed.

More preferably, the management device is operable when a name of the node of the rule name on the left side of the rule definition has been changed, to change names of all nodes of the rule reference referring to the node of the rule name the name of which has been changed.

More preferably, the speech recognition grammar creating apparatus further comprises a pasting device that creates a copy of at least one of the nodes and the links of each of the rule definitions, and pastes the copy of the at least one of the nodes and the links, and the pasting device is inhibited from pasting the copy of the at least one of the nodes and the links, when the node of the rule name on the left side of the rule definition of which the at least one of the nodes and the links are to be pasted already exists in the same grammar.

To attain the above object, in a second aspect of the present invention, there is provided a method of creating a speech recognition grammar, comprising a display control step of providing control such that a rule name of at least one rule definition is displayed as a node on a left side of the rule definition and at least one of word and rule reference of the rule definition are displayed as nodes on a right side of the rule definition, and an edit step of editing the rule definition by connecting the node on the left side and the nodes on the right side by links, wherein the edit step comprises displaying rule definitions of a same grammar on a same window, and replacing nodes and links of each of the rule definitions between the rule definitions on the same window.

To attain the above object, in a third aspect of the present invention, there is provided a program for causing a computer to execute a method of creating a speech recognition grammar, comprising a display control module for providing control such that a rule name of at least one rule definition is displayed as a node on a left side of the rule definition and at least one of word and rule reference of the rule definition are displayed as nodes on a right side of the rule definition, and an edit module for editing the rule definition by connecting the node on the left side and the nodes on the right side by links, wherein the edit module is capable of displaying rule definitions of a same grammar on a same window, and replacing nodes and links of each of the rule definitions between the rule definitions on the same window.

To attain the above object, in a fourth aspect of the present invention, there is provided a computer-readable storage medium storing the program according to the third aspect of the present invention.

The above and other objects, features, and advantages of the invention will become more apparent from the following detailed description taken in conjunction with the accompany drawings.

### BRIEF DESCRIPTION OF THE DRAWINGS

FIG. 1 is a block diagram showing the configuration of a speech recognition grammar creating apparatus according to an embodiment of the present invention;

FIG. 2 is a flowchart showing a process executed when the user has created a rule reference node on the right side of a rule definition;

FIGS. 3A to 3C are diagrams showing an example of edit windows changing according to the process in FIG. 2;

FIGS. 4A to 4C are diagrams showing examples of windows useful in explaining a case where a rule reference node associated with a rule name node already registered has been changed, wherein:

FIG. 4A is a diagram showing an example of a window displaying rule reference nodes associated with the rule name node already registered;

FIG. 4B is a diagram showing an example of a window displayed when the user has changed the name “station” of a third rule reference node to the name “airport”; and

FIG. 4C is a diagram showing an example of a window displayed when a new rule name node has been created according to the change of the name of the third rule reference node in FIG. 4B;

FIG. 5 is a flowchart showing a process executed where the name of a rule name node has been changed;

FIGS. 6A and 6B are diagrams showing an example of edit windows changing according to the process in FIG. 5, in which:

FIG. 6A is a diagram showing an example of a window displayed when the name “airport” of a rule name node has been changed to the name “airport_{—}2”; and

FIG. 6B is a diagram showing an example of a window displaying the changed name of rule reference nodes resulting from the change of the name of the rule name node in FIG. 6A;

FIG. 7 is a flowchart showing a process for storing edit results;

FIGS. 8A to 8C are diagrams useful explaining the process for storing edit results, in which:

FIG. 8A is a diagram showing an example of a table for managing data being edited, by internal expressions;

FIG. 8B is a diagram showing an example of a table for managing the notation and pronunciation of words; and

FIG. 8C is a diagram showing an example of the edit results stored as a text grammar;

FIG. 9 is a diagram showing an example of a window displaying data being edited, which cannot be stored as a text grammar;

FIGS. 10A and 10B are diagrams useful in explaining a process for storing edit results, in which:

FIG. 10A is a diagram showing an example of a window displaying data being edited, which can be stored as a text grammar; and

FIG. 10B is a diagram showing an example of results of storing the FIG. 10A data being edited, as GUI data;

FIG. 11 is a flowchart showing a process for inputting stored edit results via a file input and output section of the speech recognition grammar creating apparatus in FIG. 1;

FIG. 12 is a diagram showing an example of a window displaying edit results stored as a text grammar, after automatically shaping the same;

FIG. 13 is a flowchart showing a process for collectively selecting a plurality of nodes and links to copy the same, and pasting the copied nodes and links; and

FIG. 14 is a diagram showing an example of an operation window for realizing a method of avoiding incapability of pasting in the case of occurrence of duplication of a rule name node, when performing the process for collectively selecting a plurality of nodes and links to copy the same, and pasting the copied nodes and links.

### DETAILED DESCRIPTION OF THE PREFERRED EMBODIMENTS

The present invention will now be described in detail with reference to the drawings showing an embodiment thereof.

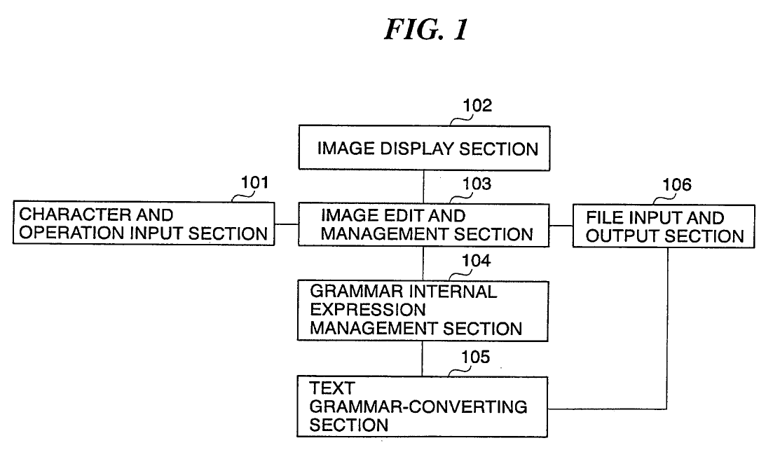

FIG. 1 is a block diagram schematically showing the configuration of a speech recognition grammar creating apparatus according to an embodiment of the present invention.

As shown in FIG. 1, the speech recognition grammar creating apparatus is comprised of a character and operation input section 101, an image display section 102, an image edit and management section 103, a grammar internal expression management section 104, a text grammar-converting section 105, and a file input and output section 106.

The character and operation input section 101 is comprised of a keyboard and a mouse, neither of which is shown. The image display section 102 is comprised of a liquid crystal display, not shown, for graphically displaying a grammar being edited. The image edit and management section 103 receives information on editing operations carried out by the user using the character and operation input section 101, and edits and manages image data being edited according to the information on the input editing operations. The grammar internal expression management section 104 converts the graphically displayed grammar into internal expressions of a grammar and manages the same.

The text grammar converting section 105 converts the internal expressions of the grammar into a text grammar and vice versa. The file input and output section 106 inputs and outputs image data edited and graphically displayed and the grammar the internal expressions of which have been converted into the text grammar, as a file.

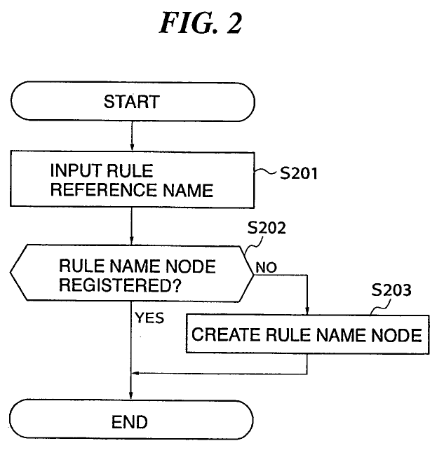

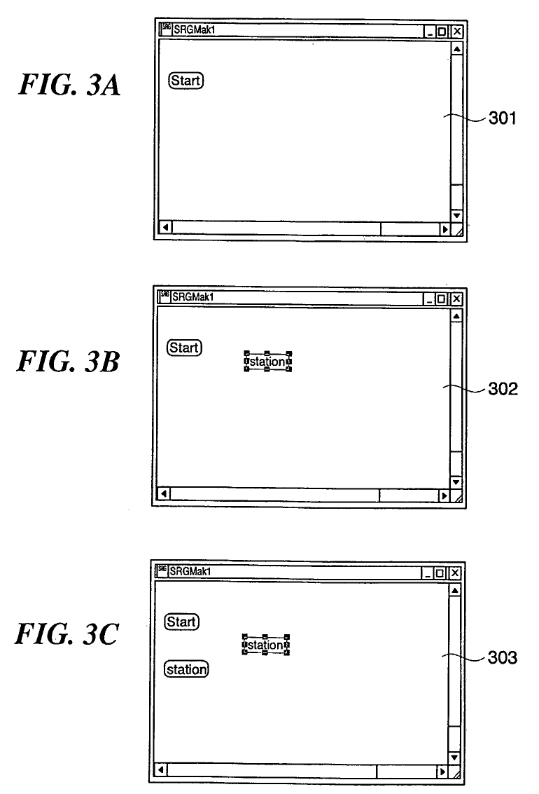

Next, a description will be given of a process executed when the user has created a rule reference node on the right side of a rule definition, with reference to FIGS. 2 and 3. FIG. 2 is a flowchart showing the process executed when the user has created the rule reference node on the right side of the rule definition. FIGS. 3A to 3C are diagrams showing an example of edit windows changing according to the process in FIG. 2.

First, it is assumed here that the image display section 102 displays a window 301 in a state where the user has newly created a grammar. On the window 301, there is displayed an icon “Start” as a node in a rectangular box with rounded corners, which has been automatically created, according to a default start rule. On the window 301, the user generates nodes on the right side of “Start”, and links the nodes on the right side and the node on the left side, i.e. “Start”, to thereby describe a rule.

Specifically, on the window 301, as shown in FIG. 2, first, a rule reference name “station” is input to a rule reference node which has been generated on the right side (step S201). The state in which the rule reference name has been input is shown on a window 302 in FIG. 3B. Then, it is checked whether or not a rule name node on the left side has already been registered (step S202). If it is determined here that the rule name node on the left side has not been registered yet, the rule name node is created (step S203). This state is shown on a window 303 in FIG. 3C. On the window 303, an icon “station” in a rectangular box with rounded corners is displayed at a lower left location, as the rule name node, followed by terminating the process.

In the step S202, if it is determined that the rule name node on the left side has already been registered, the present process is immediately terminated.

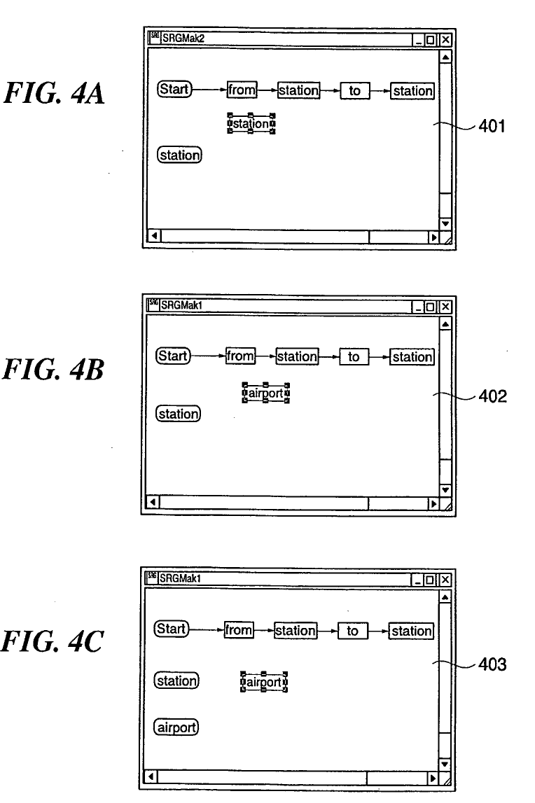

Next, a description will be given of a process executed upon changing the name of a rule reference node associated with a rule name node already registered, with reference to FIGS. 4A to 4C. FIG. 4A is a diagram showing an example of a window displaying rule reference nodes associated with the rule name node already registered; FIG. 4B is a diagram showing an example of a window displayed when the user has changed the name “station” of a third rule reference node to the name “airport”; and FIG. 4C is a diagram showing an example of a window displayed when a new rule name node has been created according to the change of the name of the third rule reference node in FIG. 4B.

For example, as shown in a window 401, when the third rule reference node “station” has been created, the rule name node “station” associated with the rule reference node has already been registered, and therefore no rule name node is created for the third rule reference node “station”. That is, a rule name node having the same name as the existing one is not created.

In the state shown in the window 401, as shown in a window 402, when the user changes the name “station” of the floating rule reference node to a name “airport”, since there is no rule name node “airport” registered, the rule name node “airport” is created and added below the rule name node “station”, as shown in a window 403.

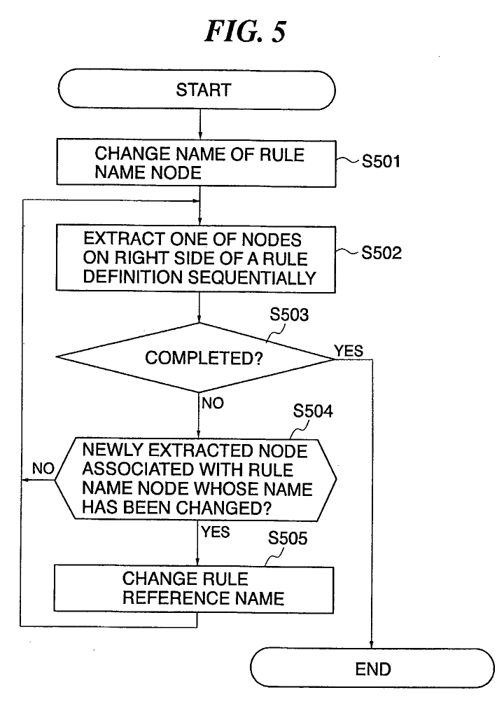

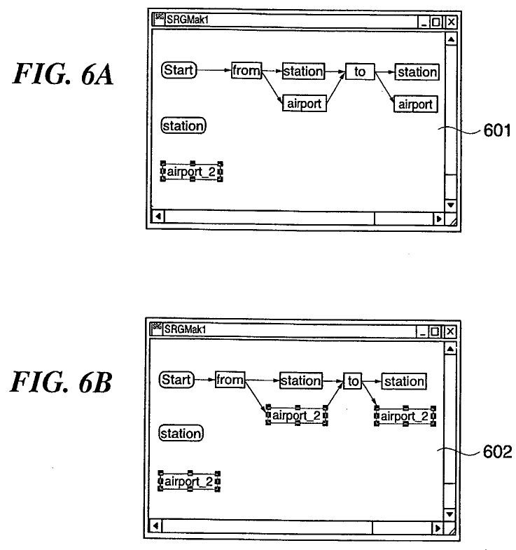

Next, a description will be given of a process executed upon changing the name of a rule name node (rule name), with reference to FIGS. 5, 6A and 6B. FIG. 5 is a flowchart showing the process executed upon changing the name of the rule name node, and FIG. 6A is a diagram showing an example of a window displayed when the name “airport” of a rule name node has been changed to the name “airport_{—}2”, and FIG. 6B is a diagram showing an example of a window displaying the changed name of rule reference nodes resulting from the change of the name of the rule name node in FIG. 6A.

When the name of a rule name node has been changed to a new name, a process is executed for collectively changing the names of rule reference nodes that refer to the rule name node to the new name. More specifically, as shown in FIG. 5, first, a change of the name of the rule name node (rule name) is accepted (step S501). In this case, in a window 601, for example, the name “airport” of the rule name node is changed to the name “airport_{—}2”.

Then, one of the nodes on the right side of the rule definition in the same grammar is extracted (step S502), and it is determined whether or not extraction of all the nodes on the right side corresponding to the rule name node on the left side has been completed (step S503). If the extraction of all the nodes on the right side corresponding to the left side node has not been completed, it is determined whether or not the rule name node with which the node newly extracted in the step S502 is associated has had its name (rule name) changed (S504). If the rule name node with which the newly extracted node is associated has had its name (rule name) changed, the name of the extracted node on the right side is changed to the changed name of the associated rule name node (step S505). For example, when the name “airport” of a rule name node has been changed into the name “airport_{—}2” as shown in the window 601 in FIG. 6A, the name “airport” of two associated rule reference nodes is automatically changed to the name “airport_{—}2”, as shown in a window 602 in FIG. 6B, followed by the process returning to the step S502.

When it is determined that the rule name node with which the newly extracted node is associated has not have its name (rule name) changed, the process returns to the step S502. Further, if it is determined in the step S503 that the extraction of all the nodes on the right side corresponding to the rule name node on the left side has been completed, the present process is immediately terminated.

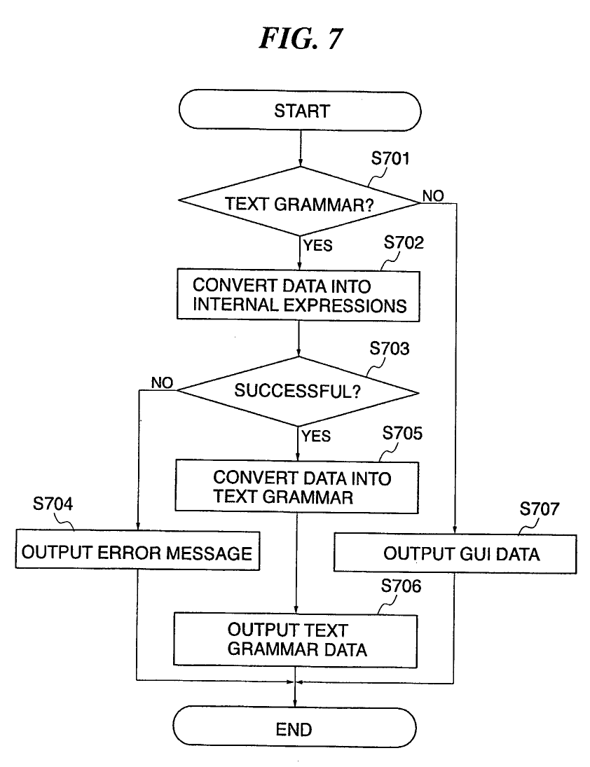

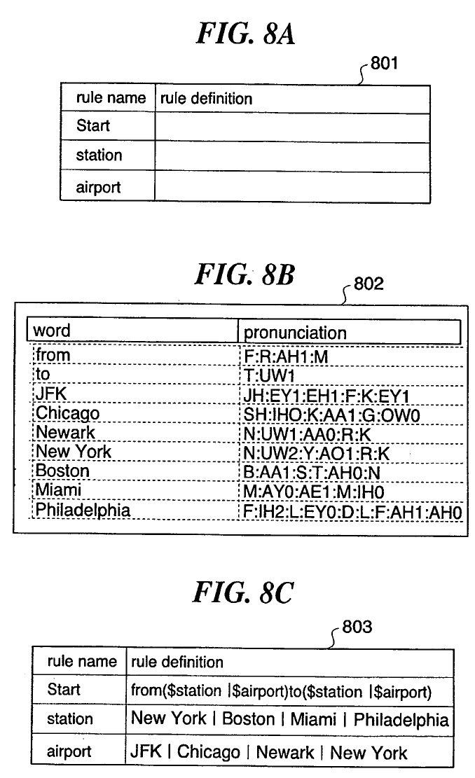

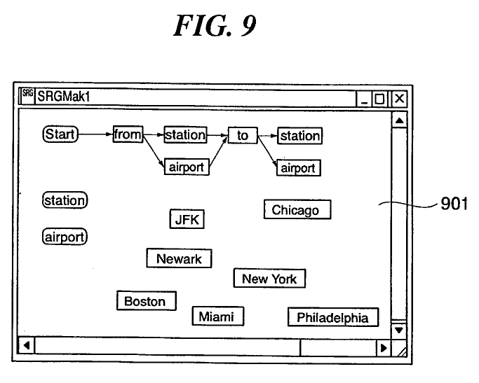

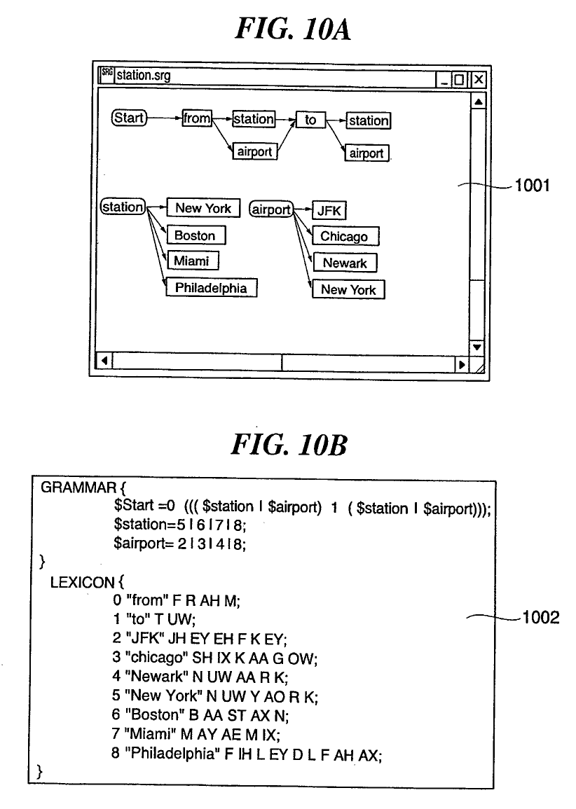

Next, a description will be given of a process for storing edit results, with reference to FIGS. 7 to 10. FIG. 7 is a flowchart showing a process for storing edit results; FIG. 8A is a diagram showing an example of a table for managing data being edited by internal expressions; FIG. 8B is a diagram showing an example of a table for managing the notation and pronunciation of words; FIG. 8C is a diagram showing an example of the edit results stored as a text grammar; FIG. 9 is a diagram showing an example of a window displaying data being edited, which cannot be stored as a text grammar; FIG. 10A is a diagram showing an example of a window displaying data being edited, which can be stored as a text grammar; and FIG. 10B is a diagram showing an example of results of storing the FIG. 10A data being edited, as GUI data.

To store edit results, the user designates a storage method of storing the results. The storage method which can be designated by the user includes a method of storing the edit results after converting the same into text grammar data, and a method of storing the edit results as GUI (Graphical User Interface) data.

When the storage method has been designated by the user, as shown in FIG. 7, first, it is determined whether or not the designated method is for storage of the edit results as a text grammar (step S701). If the designated method is for storage as a text grammar, internal expressions are created based on the image data being edited (step S702). As to the data being edited, the rule names and the pronunciation and notation of each word are managed as internal expressions, but details of the definition of each rule are not managed. For example, as in a table 801 shown in FIG. 8A, the rule names are registered and managed, but details of the definitions thereof are left blank. As in a table 802 shown in FIG. 8B, the notation and pronunciation of each word are managed. When the edit results are stored as a text grammar, the details of the definitions of the rules are converted into internal expressions to be reconstructed.

Next, it is determined whether or not the conversion into the internal expressions has been successful (step S703). For example, as in a window 901 shown in FIG. 9, if there are rule name nodes having no definitions (no branches on the right side), or word nodes which are not associated with any other nodes, they cannot be properly converted into a text grammar. If the conversion into internal expressions has failed as in this case, the image display section 102 displays an error message saying that the edit results cannot be stored (step S704), followed by terminating the process.

On the other hand, when it is determined in the step S703 that the conversion into internal expressions has been successful, the edit results are converted into character strings of the text grammar (step S705), and the text grammar data is output to the file input and output section 106 (step S706), followed by terminating the present process. For example, in the case of data being edited, which is displayed in a window 1001 shown in FIG. 10A, it is possible to generate details of definitions of the rules by internal expressions, as in a table 803 shown in FIG. 8C.

If it is determined in the step S701 that the designated method is not for storage as a text grammar, i.e. it is for storage of the edit results as GUI (Graphical User Interface) data, the data being edited is output to the file input and out section 106 as GUI data (step S707), followed by terminating the present program. For example, to store data being edited, as displayed on the window 1001 shown in FIG. 10A, as GUI data, results 1002 to be stored shown in FIG. 10B is obtained as the results of edit of the data being edited. When stored as GUI data, the file of the stored GUI data is binary data. Further, in the case of GUI data, information on respective locations of graphic components is designated and stored, and therefore it is also possible to store information on locations designated by the user. Further, in this case, conversion of the data into internal expressions is not executed, and therefore it is possible to store the data being edited, as shown in FIG. 9, as GUI data.

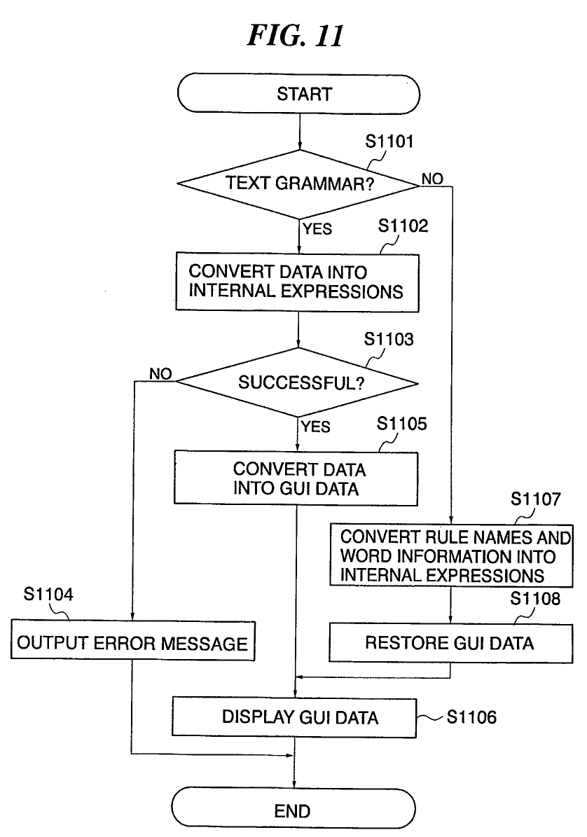

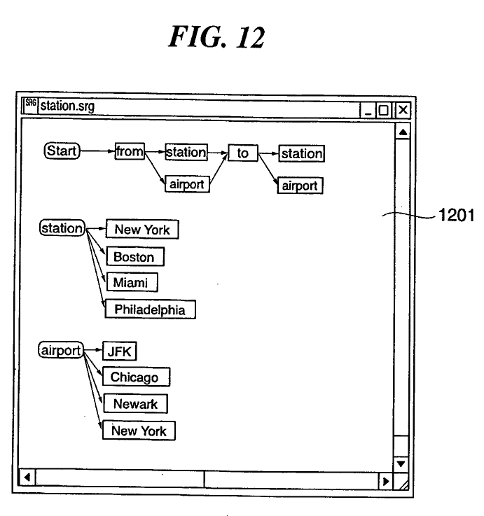

Next, a description will be given of a process for inputting the stored edit results via the file input and output section 106, with reference to FIGS. 11 and 12. FIG. 11 is a flowchart showing the process for inputting stored edit results via the file input and output section 106, and FIG. 12 is a diagram showing an example of a window displaying edit results stored as a text grammar, after automatically shaping the same.

When inputting the stored edit results via the file input and output section 106, as shown in FIG. 11, first, it is determined whether or not the stored data of the edit results to be input via the file input and output section 106 is in the form of a text grammar (step S1101) When the stored data of the edit results is in the form of a text grammar, the input data of the edit results is converted into internal expressions (step S1102), and it is determined whether or not the conversion has been successful (step S1103). For example, when the edit results do not conform to a text grammar, it is impossible to carry out the conversion into internal expressions, and therefore the conversion fails. When the conversion into internal expressions has failed, as stated above, an error message indicating the failure is displayed on the image display section 102 (step S1104), followed by terminating the present process. In this case, the inputting of the edit results is not carried out.

When it is determined in the step S1103 that the conversion has been successful, the data of the edit results is converted into GUI data (step S1105), and the GUI data is displayed on the image display section 102 (step S1106). The data input here is in the form of a text grammar, and therefore information on the locations of nodes and the like is automatically shaped. For example, as in a window 1201 shown in FIG. 12, the text grammar data is displayed on the image display section 102 after being automatically shaped.

When it is determined in the step S1101 that the stored data is not in the form of a text grammar, the edit results are input as GUI data, and therefore conversion of the rule names and word information into internal expressions is executed (step S1107). Then, the GUI data is restored from the stored data (step S1108), and the restored GUI data is displayed on the image display section 102 (step S1106). In this case, as in the window 1001 shown in FIG. 10A, the information on locations of nodes arranged by the user is also reproduced.

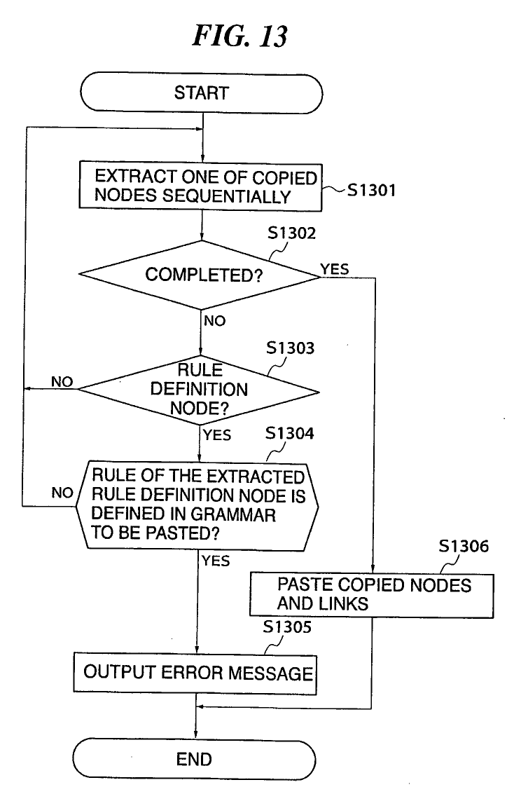

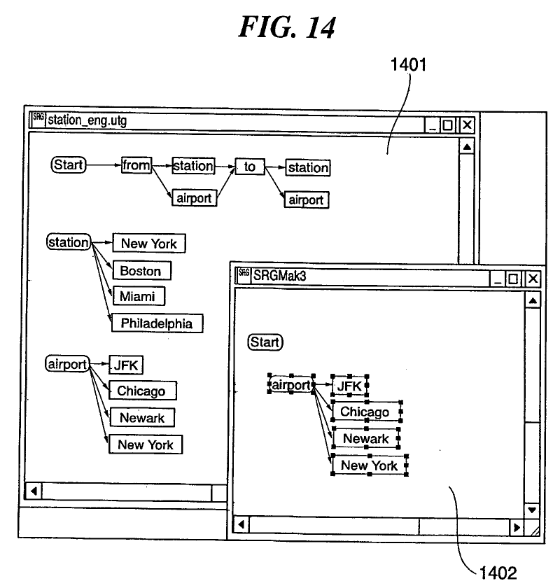

Next, a description will be given of a process for collectively selecting a plurality of nodes and links to copy the same, and pasting the copied nodes and links, with reference to FIGS. 13 and 14. FIG. 13 is a flowchart showing the process for collectively selecting a plurality of nodes and links to copy the same, and pasting the copied nodes and links, and FIG. 14 is a diagram showing an example of an operation window for realizing a method of avoiding incapability of pasting in the case of occurrence of duplication of a rule name node, when performing the process for collectively selecting a plurality of nodes and links to copy the same, and pasting the copied nodes and links.

When the user gives an instruction for pasting the collectively selected nodes and links via the character and operation input section 101, first, the copied nodes are sequentially extracted (step S1301), as shown in FIG. 13. Then, it is determined whether or not all of the copied nodes have been extracted (step S1302). If all of the copied nodes have been extracted, the copied nodes and links are pasted (step S1306), followed by terminating the process. It should be noted that when there is no copied node or link, the step S1306 is automatically skipped over, followed by terminating the present process.

If it is determined in the step S1302 that all of the copied nodes have not been extracted, it is determined whether or not the extracted node is a rule definition node (step S1303). If the extracted node is not a rule definition node, the process is repeatedly executed from the step S1301. On the other hand, if the extracted node is a rule definition node, it is determined whether or not the rule of the extracted rule definition node is defined in the grammar to which the extracted rule definition node is to be pasted (step S1304). If the rule is not defined, the process is repeatedly executed from the step S1301. On the other hand, if the rule is defined, an error message indicating that the pasting is not allowed is displayed on the image display section 102, followed by terminating the present process. That is, the pasting of nodes and links, including a rue definition node, is not allowed on a grammar already including the rule of the rule definition node, but allowed on another grammar.

When the pasting of the nodes and links including the rule definition node is not allowed at a grammar as a pasting destination, a new grammar window is temporarily generated, and the whole rule is copied and the copied rule is pasted to the new grammar window. Then, the rule name is changed on the new grammar window, and the changed rule is pasted together with the rule definitions onto the original grammar window. This procedure can realize the pasting of nodes and links including the rule definition node. For example, as shown in FIG. 14, in addition to an original grammar window 1401, a new grammar window 1402 is separately created, and then, the rule of “airport” is copied together with the right side nodes thereof from the original grammar window 1401 and pasted to the new separate grammar window 1402. Then, the rule name is changed, and the changed rule is pasted together with the rule definitions to the original grammar window 1401.

As described heretofore, according to the present embodiment, it is possible to easily carry out editing operations, such as division and modification, on the rule, without switching the window to another.

Further, as the method which can be designated for storage of edit results, there are provided a method of storing the edit results as text grammar data after conversion of the edit results, and a method of storing the edit results as GUI (Graphical User Interface) data. Therefore, data being edited which cannot be described in ABNF or the like can be also stored, and used again.

Although in the present embodiment, to distinguish a rule name node as the left side of a rule definition from the nodes on the right side of the same, the rule name node is displayed as an icon of a rectangular box with four rounded corners, this is not limitative, but the nodes on the left side may be distinguished from those on the right side, using different frames or background color. Further, a boundary line may be provided between the nodes on the left side and the nodes on the right side to distinguish the former from the latter.

Further, although in the present embodiment, one type of conversion of edit results into text grammar data is employed, this is not limitative, but the speech recognition grammar creating apparatus according to the present invention may support conversion of edit results into a plurality of types of text grammar data. In this case, it is required to provide a plurality of converting paths that are selected to convert internal expressions into the respective plurality of types of text grammar data.

Further, although in the present embodiment, beside the method of storing edit results as GUI data, there is employed the method of storing edit results as text grammar data, this is not limitative, but the results edits may be output as a grammar in a binary form which is supported by a speech recognition engine.

Furthermore, although in the present embodiment, when there is a rule without a definition or a word or a rule reference node not used in a node on the right side, it is presumed that creation of internal expressions will be unsuccessful, and edit results including such a rule or word is inhibited from being output as text grammar data, this is not limitative, but even when the edit results are incomplete as a text grammar, only portions which can be output may be output.

It is to be understood that the object of the present invention may also be accomplished by supplying a system or an apparatus with a storage medium in which a program code of software, which realizes the functions of the above described embodiment is stored, and causing a computer (or CPU or MPU) of the system or apparatus to read out and execute the program code stored in the storage medium.

In this case, the program code itself read from the storage medium realizes the functions of the above described embodiment, and therefore the program code and the storage medium in which the program code is stored constitute the present invention.

Examples of the storage medium for supplying the program code include a floppy (registered trademark) disk, a hard disk, a magnetic-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program may be downloaded via a network from another computer, a database, or the like, not shown, connected to the Internet, a commercial network, a local area network, or the like.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

### CROSS REFERENCE TO RELATED APPLICATION

This application claims priority from Japanese Patent Application No. 2004-170290 filed Jun. 8, 2004, which is hereby incorporated by reference herein.

1. A speech recognition grammar creating apparatus comprising:
a display control device that provides control such that a rule name of at least one rule definition is displayed as a node on a left side of the rule definition and at least one of word and rule reference of the rule definition are displayed as nodes on a right side of the rule definition; and
an edit device that edits the rule definition by connecting the node on the left side and the nodes on the right side by links,
wherein said edit device is capable of displaying rule definitions of a same grammar on a same window, and replacing nodes and links of each of the rule definitions between the rule definitions on the same window.

2. A speech recognition grammar creating apparatus as claimed in claim 1, further comprising a storage device that is capable of readably storing edit results obtained by said edit device, in a storage method selected from a first storage method in which the edit results are stored as information consisting of grammar information necessary for speech recognition, and a second storage method in which the edit results are stored as information including the grammar information necessary for speech recognition and information on a location and a shape of each node and a location and a shape of each link.

3. A speech recognition grammar creating apparatus as claimed in claim 1, further comprising:
a management device that manages rule names and words of the grammar; and
wherein said management device is operable when the node of the rule reference has been created on the right side of the rule definition, to automatically create the node of the rule name associated with the created node of the rule reference on the left side of the rule definition.

4. A speech recognition grammar creating apparatus as claimed in claim 3, wherein said management device is operable when the node of the rule reference has been newly created on the right side of the rule definition, to inhibit the node of the rule name associated with the created node of the rule reference from being newly created on the left side of the rule definition, provided that the node of the rule name associated with the created node of the rule reference already exists.

5. A speech recognition grammar creating apparatus as claimed in claim 3, wherein said management device is operable when a name of the rule reference of the node of the rule reference on the right side of the rule definition has been changed, to automatically create the node of the rule name associated with the node of the rule reference the name of which has been changed.

6. A speech recognition grammar creating apparatus as claimed in claim 3, wherein said management device is operable when a name of the node of the rule name on the left side of the rule definition has been changed, to change names of all nodes of the rule reference referring to the node of the rule name the name of which has been changed.

7. A speech recognition grammar creating apparatus as claimed in claim 3, further comprising:
a pasting device that creates a copy of at least one of the nodes and the links of each of the rule definitions, and pastes the copy of the at least one of the nodes and the links; and
wherein said pasting device is inhibited from pasting the copy of the at least one of the nodes and the links, when the node of the rule name on the left side of the rule definition of which the at least one of the nodes and the links are to be pasted already exists in the same grammar.

8. A method of creating a speech recognition grammar, comprising:
a display control step of providing control such that a rule name of at least one rule definition is displayed as a node on a left side of the rule definition and at least one of word and rule reference of the rule definition are displayed as nodes on a right side of the rule definition; and
an edit step of editing the rule definition by connecting the node on the left side and the nodes on the right side by links,
wherein said edit step comprises displaying rule definitions of a same grammar on a same window, and replacing nodes and links of each of the rule definitions between the rule definitions on the same window.

9. A program for causing a computer to execute a method of creating a speech recognition grammar, comprising:
a display control module for providing control such that a rule name of at least one rule definition is displayed as a node on a left side of the rule definition and at least one of word and rule reference of the rule definition are displayed as nodes on a right side of the rule definition; and
an edit module for editing the rule definition by connecting the node on the left side and the nodes on the right side by links,
wherein said edit module is capable of displaying rule definitions of a same grammar on a same window, and replacing nodes and links of each of the rule definitions between the rule definitions on the same window.

10. A computer-readable storage medium storing the program as claimed in claim 9.
